(19) United States
(12) Patent Application Publication
(10) Pub. No.: US 2026/0268901 A1
(43) Pub. Date: Sep. 10, 2026

(54) APPARATUS FOR DETERMINING AN UTTERANCE INTENTION AND A METHOD THEREOF

(71) Applicants: HYUNDAI MOTOR COMPANY, Seoul (KR); KIA CORPORATION, Seoul (KR)

(72) Inventors: Hyun Soo Cho, Hwaseong-si (KR); Han Woong Choi, Hwaseong-si (KR)

(73) Assignees: HYUNDAI MOTOR COMPANY, Seoul (KR); KIA CORPORATION, Seoul (KR)

(21) Appl. No.: 19/302,998

(22) Filed: Aug. 18, 2025

(30) Foreign Application Priority Data
Mar. 10, 2025 (KR) 10-2025-0030889

(51) Int. Cl. G10L 15/22; G06N 3/045; G10L 15/16

(52) U.S. Cl. CPC G10L 15/22; G06N 3/045; G10L 15/16

(57) ABSTRACT

An utterance intention determining apparatus includes a non-transitory memory that stores computer-executable instructions. The utterance intention determining apparatus further includes a processor coupled with the memory and configured to execute the computer-executable instructions stored in the memory. The processor is configured to identify at least one target sentence for which utterance intention was not previously determined by a server, from speech information corresponding to speech of a user, perform preprocessing on the at least one target sentence based on at least one utterance feature included in the at least one target sentence, obtain the utterance intention of the at least one target sentence by applying the at least one target sentence to a large language model (LLM) based on performing preprocessing on the at least one target sentence, and transmit the utterance intention of the at least one target sentence to the server.

### CROSS-REFERENCE TO RELATED APPLICATION

This application claims the benefit of and priority to Korean Patent Application No. 10-2025-0030889, filed in the Korean Intellectual Property Office on Mar. 10, 2025, the entire disclosure of which is incorporated herein by reference.

### TECHNICAL FIELD

The present disclosure relates to an utterance intention determining apparatus and a method thereof. More particularly, the present disclosure relates to technology for generating an utterance intention of an utterance sentence and transmitting the generated utterance intention to an intention classifier if the utterance intention of a user's utterance sentence was not previously determined by the predetermined intention classifier.

### BACKGROUND

Conversational artificial intelligence (AI) systems such as service robots, AI chatbots, and virtual assistants have been in use in various industries. To naturally interact with users, these systems analyze users' utterances by using natural language processing (NLP) and intention recognition technologies and provide appropriate responses.

In general, these conversational systems operate based on predefined utterance intention and classify the intention of a user's utterance with reference to pre-built utterance intention data. Afterwards, a method may be used to return a predefined response corresponding to each intention.

However, if the user's utterance falls outside of the pre-built utterance intent categories (out of domain (OOD), the system may fail to provide an appropriate response. To solve these issues, the system should be maintained and improved. However, conventional technology includes limitations due to manual processing, problems with processing large amounts of data, and difficulties in extending the scope of the utterance intention.

### SUMMARY

The present disclosure provides a technical solution to the above-mentioned problems occurring in the prior art while maintaining other technological solutions.

The present disclosure automatically analyzes utterances by using deep learning and large language models (LLMs) and generates a new utterance intention. In particular, the present disclosure maintains and improves an utterance system by continuously adding a new utterance intention.

An aspect of the present disclosure provides an utterance intention determining apparatus that may extract meaningful data from a user's utterance data, may construct utterance intention, and may respond to an utterance for which the intention is not previously classified, and a method thereof.

The technical problems to be solved by the present disclosure are not limited to the aforementioned problems. Any other technical problems not mentioned herein should be clearly understood from the following description by those of ordinary skill in the art to which the present disclosure pertains.

According to an aspect of the present disclosure, an utterance intention determining apparatus includes a non-transitory memory that stores computer-executable instructions. The utterance intention determining apparatus further includes a processor coupled with the memory and configured to execute the computer-executable instructions stored in the memory. The processor is also configured to identify at least one target sentence for which utterance intention was not previously determined by a server from speech information corresponding to speech of a user. The processor is further configured to perform preprocessing on the at least one target sentence based on at least one utterance feature included in the at least one target sentence. The processor is further configured to obtain the utterance intention of the at least one target sentence by applying the at least one target sentence to a large language model (LLM) based on performing preprocessing on the at least one target sentence. The processor is also configured to transmit the utterance intention of the at least one target sentence to the server.

In an embodiment, the processor may extract the at least one utterance feature from the at least one target sentence and may perform preprocessing on the at least one target sentence based on at least one of a length of the at least one utterance feature, a number of times that the at least one utterance feature is repeated, or importance of the at least one utterance feature, or any combination thereof.

In an embodiment, the processor may be configured to extract a first target sentence and a second target sentence from the at least one target sentence. The processor may be further configured to obtain a first translation sentence based on the first target sentence being converted into a predetermined language by applying the first target sentence to the LLM. The processor may be also configured to obtain a first embedding vector by applying the first translation sentence to a Bidirectional Encoder Representations from Transformers (BERT) model.

In an embodiment, the processor may be configured to obtain a second translation sentence based on the second target sentence being converted into the predetermined language, by applying the second target sentence to the LLM, and may obtain a second embedding vector by applying the second translation sentence to the BERT model.

In an embodiment, the processor may perform clustering on the first translation sentence and the second translation sentence based on the first embedding vector and the second embedding vector.

In an embodiment, the processor may obtain utterance intention of a cluster by applying the first translation sentence and the second translation sentence to the LLM based on the first translation sentence and the second translation sentence being included in the same cluster.

In an embodiment, the processor may obtain utterance intention of each of the first translation sentence and the second translation sentence by applying the first translation sentence and the second translation sentence to the LLM at different time points based on the first translation sentence and the second translation sentence being included in different clusters.

In an embodiment, the processor may control a robot based on the utterance intention of the at least one target sentence based on transmitting the utterance intention of the at least one target sentence to the server.

In an embodiment, the utterance feature may include at least one of a vocabulary of the target sentence, a topic of the target sentence, a dialect of the user, an intonation of the user, a stem of the target sentence, an ending of the target sentence, a pitch of the target sentence, or an utterance speed of the user, or any combination thereof.

According to an aspect of the present disclosure, an utterance intention determining method includes identifying at least one target sentence for which utterance intention is not determined by a server, from speech information corresponding to speech of a user. The method further includes performing preprocessing on the at least one target sentence based on at least one utterance feature included in the at least one target sentence. The method further includes obtaining utterance intention of the at least one target sentence by applying the at least one target sentence to an LLM based on performing preprocessing on the at least one target sentence. The method further includes transmitting the utterance intention of the at least one target sentence to the server.

In an embodiment, performing the preprocessing on the at least one target sentence may include extracting the at least one utterance feature from the at least one target sentence. Performing the preprocessing further includes performing preprocessing on the at least one target sentence based on at least one of a length of the at least one utterance feature, a number of times that the at least one utterance feature is repeated, or importance of the at least one utterance feature, or any combination thereof.

In an embodiment, obtaining the utterance intention of the at least one target sentence may include extracting a first target sentence and a second target sentence from the at least one target sentence. Obtaining the utterance intention may further include obtaining a first translation sentence based on the first target sentence being converted into a predetermined language, by applying the first target sentence to the LLM. Obtaining the utterance intention may further include obtaining a first embedding vector by applying the first translation sentence to a BERT model.

In an embodiment, obtaining the utterance intention of the at least one target sentence may include obtaining a second translation sentence based on the second target sentence being converted into the predetermined language, by applying the second target sentence to the LLM. Obtaining the utterance may further include obtaining a second embedding vector by applying the second translation sentence to the BERT model.

In an embodiment, obtaining the utterance intention of the at least one target sentence may include performing clustering on the first translation sentence and the second translation sentence based on the first embedding vector and the second embedding vector.

In an embodiment, obtaining the utterance intention of the at least one target sentence may include obtaining utterance intention of a cluster by applying the first translation sentence and the second translation sentence to the LLM based on the first translation sentence and the second translation sentence being included in the same cluster.

In an embodiment, obtaining the utterance intention of the at least one target sentence may include obtaining utterance intention of each of the first translation sentence and the second translation sentence by applying the first translation sentence and the second translation sentence to the LLM at different time points based on the first translation sentence and the second translation sentence being included in different clusters.

In an embodiment, transmitting the utterance intention of the at least one target sentence to the server may include controlling a robot based on the utterance intention of the at least one target sentence based on transmitting the utterance intention of the at least one target sentence to the server.

### BRIEF DESCRIPTION OF THE DRAWINGS

The above and other objects, features and advantages of the present disclosure should be more apparent from the following detailed description taken in conjunction with the accompanying drawings:

FIG. 1 is a block diagram illustrating an utterance intention determining apparatus, according to an embodiment of the present disclosure;

FIG. 2 is a flowchart for describing an utterance intention determining method, according to an embodiment of the present disclosure;

FIG. 3 is a diagram illustrating a method for identifying a target sentence in an utterance intention determining apparatus, according to an embodiment of the present disclosure;

FIG. 4 is a diagram illustrating a method for obtaining utterance intention of a target sentence for which an utterance intention is not determined, by an utterance intention determining apparatus, according to an embodiment of the present disclosure;

FIG. 5 is a diagram illustrating an interface for transmitting obtained utterance intention to an intention classifier by an utterance intention determining apparatus, according to an embodiment of the present disclosure;

FIG. 6 is a flowchart illustrating a method for obtaining utterance intention of a target sentence for which an utterance intention is not determined, by an utterance intention determining apparatus, according to an embodiment of the present disclosure; and

FIG. 7 is a diagram illustrating a computing system associated with an utterance intention determining apparatus or an utterance intention determining method, according to an embodiment of the present disclosure.

With regard to description of drawings, the same or similar components are marked by the same or similar reference numerals.

### DETAILED DESCRIPTION

Hereinafter, various embodiments of the present disclosure are described in detail with reference to the accompanying drawings. In the following drawings, the same reference numerals are used throughout to designate the same or equivalent elements, even though the elements are shown in different drawings. Furthermore, in the following description of various embodiments, a detailed description of well-known functions and configurations incorporated therein has been omitted for the purpose of clarity and for brevity. Hereinafter, various embodiments of the present disclosure may be described with reference to accompanying drawings. Accordingly, those of ordinary skill in the art should recognize that modifications, equivalents, and/or alternative various embodiments described herein may be variously made without departing from the scope and spirit of the present disclosure. With regards to description of drawings, similar components may be marked by similar reference numerals.

In describing elements of an embodiment of the present disclosure, the terms first, second, A, B, (a), (b), and the like may be used herein. These terms are only used to distinguish one element from another element, but do not limit the corresponding elements irrespective of the nature, type, order, sequence, or priority of the corresponding elements. Furthermore, unless otherwise defined, all terms, including technical or scientific terms, used herein include the same meaning as generally understood by one of ordinary skill in the art to which the present disclosure belongs. Such terms as those defined in a generally used dictionary are to be interpreted as having meanings equal to the contextual meanings in the relevant field of art and should not be interpreted has having ideal or overly formal meanings unless expressly and clearly defined as having such in the present disclosure. For example, the terms, such as “first”, “second”, and the like used herein may refer to various elements of various embodiments of the present disclosure, but do not limit the elements. For example, “a first user device” and “a second user device” may indicate different user devices regardless of the order or priority thereof. For example, without departing the scope of the present disclosure, a first component may be referred to as a second component, and similarly, a second component may be referred to as a first component.

In this specification, the expressions “possess”, “may possess”, “include” and “comprise”, or “may include” and “may comprise” used herein indicate existence of corresponding features (e.g., elements such as numeric values, functions, operations, or components) but do not exclude presence of additional features.

It should be understood that if an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, if an element (e.g., a first element) is referred to as being “directly coupled with/to” or “directly connected to” another element (e.g., a second element), it should be understood that there are no intervening elements (e.g., a third element).

According to the situation, the expression “configured to” used herein may be used as, for example, the expression “suitable for”, “including the capacity to”, “designed to”, “adapted to”, “made to”, or “capable of”.

The term “configured to” should not mean only “specifically designed to” in hardware. Instead, the expression “a device configured to” may mean that the device is “capable of” operating together with another device or other components. In other words, when a component, device, element, part, unit, module or the like of the present disclosure is described as having a purpose or performing an operation, function, or the like, the component, device, or element should be considered herein as being “configured to” meet that purpose or to perform that operation or function. For example, a “processor configured to (or set to) perform A, B, and C” may mean a dedicated processor (e.g., an embedded processor) for performing a corresponding operation or a specifically configured processor (e.g., a central processing unit (CPU) or an application processor) which performs corresponding operations by executing one or more software programs or computer-executable instructions which are stored in a memory device. The terms used in the specification are only used to describe a specific embodiment and are not intended to limit the scope of the present disclosure. In particular, each “part”, “unit”, “module”, “component”, “device”, “element”, and the like may separately embody or be included with a processor and a memory, such as a non-transitory computer readable media, as part of the apparatus.

The terms of a singular form may include plural forms unless otherwise specified. In some cases, even though terms are terms which are defined in the specification, they may not be interpreted to exclude embodiments of the present disclosure.

In the present disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. Moreover, in describing a component of an embodiment of the present disclosure, the expressions at least one of “A or B”, “at least one of A and B”, “at least one of A or B”, “A, B, or C”, “at least one of A, B, and C”, or “at least one of A, B, or C, or any combination thereof” may include any and all combinations of one or more of the associated listed items. In particular, expressions “at least one of A, B, or C, or any combination thereof” may include A, B, or C, or any combination thereof such as AB, ABC, or the like.

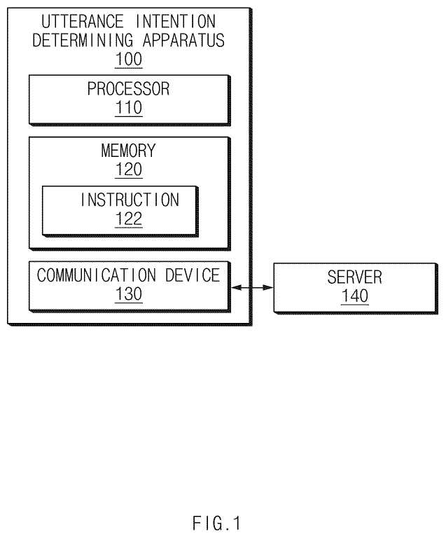

Hereinafter, embodiments of the present disclosure are described in detail with reference to FIGS. 1-7.

FIG. 1 is a block diagram illustrating an utterance intention determining apparatus, according to an embodiment of the present disclosure.

An utterance intention determining apparatus 100 according to an embodiment may include a processor 110, a memory 120 including computer-executable instructions 122, and a communication device 130.

The utterance intention determining apparatus 100 may include a hardware device that generates and/or obtains the utterance intention, i.e., the intent of an utterance by a user, of a target sentence for which an utterance intention was not previously determined from speech information corresponding to speech of a user (hereinafter, referred to as a “user utterance sentence”). In an embodiment, the utterance intention determining apparatus 100 identifies a target sentence for which the utterance intention was not previously determined by a server 140, from among the user's utterance sentences and performs preprocessing based on an utterance feature included in the target sentence. Afterwards, the utterance intention determining apparatus 100 obtains the utterance intention of each sentence by applying the preprocessed sentence to a large language model (LLM). The obtained utterance intention may be transmitted to the server 140 again such that a new utterance intention for the utterance sentence, which was not previously classified, is generated.

Even if the utterance intention is out of domain (OOD), the utterance intention determining apparatus 100 may automatically determine a new utterance intention. To this end, the utterance intention determining apparatus 100 may identify and classify a new utterance pattern by analyzing the user's utterance by using deep learning-based LLM and extracting semantic features. Accordingly, the utterance intention determining apparatus 100 may provide automated maintenance and expandability compared to conventional manually based utterance intention addition methods.

The processor 110 may execute software or computer-executable instructions and may control at least one other component (e.g., a hardware or software component) connected to, i.e., coupled with, the processor 110. The processor 110 may also perform various data processing or operations. In an embodiment, the processor 110 may store a user utterance sentence, a target sentence, an LLM, or utterance intention in the memory 120.

For reference, the processor 110 may perform all operations performed by the utterance intention determining apparatus 100. Therefore, for convenience of description in this specification, an operation performed by the utterance intention determining apparatus 100 is mainly described as an operation performed by the processor 110. Furthermore, for convenience of description in this specification, the processor 110 is mainly described as a single processor, but is not limited thereto. In an embodiment, the utterance intention determining apparatus 100 may include a plurality of processors. Each of the processors may perform all operations associated with an operation of obtaining the utterance intention of the target sentence.

The memory 120 may temporarily and/or permanently store various pieces of data and/or information required to perform the operation of obtaining the utterance intention of the target sentence. In an embodiment, the memory 120 may store a user utterance sentence, a target sentence, an LLM, or utterance intention.

The communication device 130, e.g., a communication interface, may support communication between the utterance intention determining apparatus 100 and the server 140. In an embodiment, the communication device 130 may include one or more components for communicating between the utterance intention determining apparatus 100 and the server 140. In an embodiment, the communication device 130 may include a short-range wireless communication device, a microphone, or the like. In this case, short-range communication technologies include wireless LAN (Wi-Fi), Bluetooth, ZigBee, Wi-Fi Direct (WFD), ultra-wideband (UWB), infrared data association (IrDA), Bluetooth Low Energy (BLE), and near field communication (NFC), and the like, but are not limited thereto.

The server 140 may be an intention classifier that extracts utterance intention from a user utterance sentence. The intention classifier is a module that identifies intention included in an utterance, by analyzing the utterance of a user. In a conversational AI system, the intention classifier may interpret the meaning of an utterance by using a natural language processing (NLP) technology and may classify the meaning into predefined categories.

In an embodiment, the intention classifier may classify an input of “Tell me the weather today” as “weather related” and the input “I'm bored, let's play” as “smalltalk”. However, an intention classifier may fail to correctly interpret the meaning of the utterance. Alternatively, if the meaning of the utterance corresponds to an intention that is not defined in advance, an intention classifier may classify input sentences such as “Take a picture”, “Where do you want to take a picture”, “How many percent is the battery”, or “How about the capacity of the battery” as “Unknown”. In an embodiment, the intention classifier may be, but is not limited to, Dialogflow by Google© which is a conversational agent.

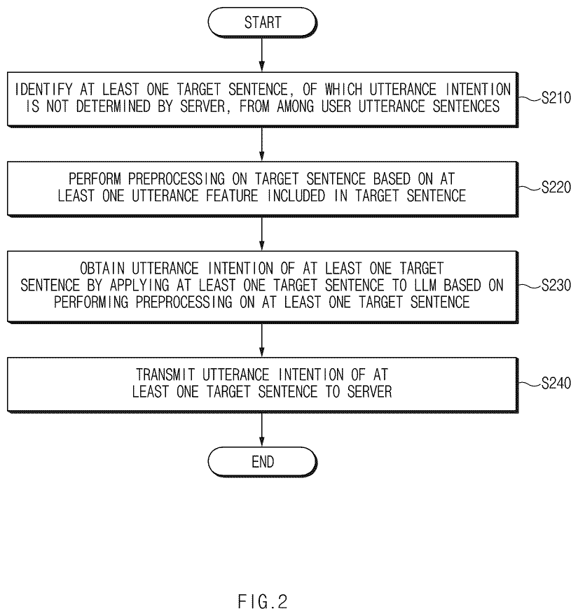

FIG. 2 is a flowchart for describing an utterance intention determining method, according to an embodiment of the present disclosure.

According to an embodiment, in operation S210, a processor (e.g., the processor 110 of FIG. 1) may identify at least one target sentence for which the utterance intention was not determined by a predetermined intention classifier, from among user utterance sentences.

A user utterance sentence refers to a sentence input by a user via voice and becomes basic data for generating an appropriate response. In an embodiment, if the user utters a sentence such as “Tell me the weather today” or “How much percent is the battery?”, the user utterance sentence is input. The user utterance sentence may include specific utterance intention.

The utterance intention indicates a semantic purpose or intention included in the user utterance sentence. In an embodiment, the sentence “Tell me the weather today” may include the utterance intention of “Request weather information (weather related)”. The utterance intention may be classified based on predefined intention categories. In detail, weather-related utterance intentions may correspond to user utterance sentences such as “Tell me the weather today” and “Will it rain?”. Food-related utterance intentions may correspond to user utterance sentences such as “Recommend a gourmet restaurant” and “What should I eat today?”

The target sentence is a sentence for which the utterance intention was not previously determined by a predetermined intention classifier. In other words, the target sentence may be a sentence that does not belong to a previously defined utterance intention category and may indicate a sentence for which the utterance intention was not determined. The target sentence remains unclassified (e.g., Unknown) in the predetermined intention classifier. Thus, a new intention needs to be generated after the target sentence is analyzed by the processor.

In operation S220, the processor may perform preprocessing on the target sentence based on at least one utterance feature included in the target sentence.

The utterance feature may refer to a key element used to analyze the meaning of the user utterance sentence. The utterance feature may include the syntax, semantics, and context of a sentence. In particular, the utterance feature may include the vocabulary of the target sentence, the topic of the target sentence, a user's dialect, the user's intonation, the stem of the target sentence, the ending of the target sentence, the pitch of the target sentence, or the user's utterance speed.

In an embodiment, the utterance feature may include lexical features, syntactic & morphological features, semantic features, acoustic features, or contextual features.

The preprocessing refers to a data processing process performed in advance to obtain the utterance intention of the target sentence and may indicate the role of removing unnecessary elements and converting data into a syntax that an LLM may use to perform a prediction.

In an embodiment, the processor may perform preprocessing on the target sentence by performing tokenization, stopword removal, morphological analysis, sentence normalization, and semantic vectorization on the target sentence. Specifically, the tokenization may indicate a task of splitting the target sentence into syntactic and morphological units. The stopword removal may refer to a task of removing words that do not include meaning from the tokenized target sentence. The morphological analysis may refer to a task of analyzing the grammatical structure of tokens from which a stopword is removed based on the part of speech of a word. The sentence normalization may refer to a task of converting an irregular expression into a standard syntax. The semantic vectorization may indicate a task of converting a sentence into an embedding vector.

In operation S230, the processor may obtain the utterance intention of the target sentence by applying the target sentence to the LLM based on performing preprocessing on the target sentence.

The LLM refers to an artificial intelligence model that may perform natural language understanding (NLU) and natural language generation (NLG) functions by learning a large amount of text data. The LLM is based on a deep neural network structure. In particular, the LLM may understand context and may generate natural text by utilizing transformer architecture.

The processor may train the LLM. In an embodiment, the LLM may include a neural network. The neural network may include a plurality of layers, and each layer may include a plurality of nodes. The node may include a node value determined based on an activation function. A node on any layer may be connected to a node (e.g., another node) on another layer through a link (e.g., a connection edge) with a connection weight. The node value of a node may be propagated to other nodes through the link. In an inference operation of the neural network, node values may be forward propagated from the previous layer to the next layer.

In an embodiment, the forward propagation operation in the LLM may indicate an operation of propagating node values based on input data in a direction from an input layer of the LLM to an output layer. In other words, the node value of the corresponding node may be propagated (e.g., forward propagated) to a node (e.g., the next node) of the next layer connected through the node and the connection edge. In an embodiment, the node may receive a value weighted by a connection weight from the previous node (e.g., a plurality of nodes) connected through the connection edge.

The node value of a node may be determined based on applying an activation function to the sum (e.g., weighted sum) of weighted values received from previous nodes. In an embodiment, a parameter of a neural network may include the connection weight described above. The parameters of the neural network may be updated such that a value of an objective function value described later changes in a targeted direction (e.g., a direction in which a loss is minimized).

The machine learning model (e.g., the trained LLM) may be created through machine learning. In an embodiment, the learning algorithm may include supervised learning, unsupervised learning, semi-supervised learning, or reinforcement learning, but is not limited to the above example.

In the case of supervised learning, the above-described machine learning model may be trained based on training data including pairs of a training input and a training output mapped to the training input. In an embodiment, the machine learning model may be trained to output the training output from the training input. The machine learning model during training may generate a temporary output in response to the training input. The machine learning model may be trained such that the loss between the temporary output and the training output (e.g., a training target) is minimized. During a training process, a parameter (e.g., a connection weight between nodes/layers in a neural network) of the machine learning model may be updated depending on the loss. In an embodiment, the training may be performed in the utterance intention determining apparatus (e.g., the utterance intention determining apparatus 100 of FIG. 1), in which a machine learning model is performed, or may be performed through a separate server (e.g., the server 140 of FIG. 1). The machine learning model (e.g., the trained LLM) in which training is completed may be stored in a memory (e.g., the memory 120 in FIG. 1).

In operation S240, the processor may transmit the utterance intention of the target sentence to the server. The processor may convert the utterance intention obtained from the LLM into a structured data format capable of being understood by the server to be transmitted. In an embodiment, the processor may transmit the utterance intention in JavaScript Object Notation (JSON) format.

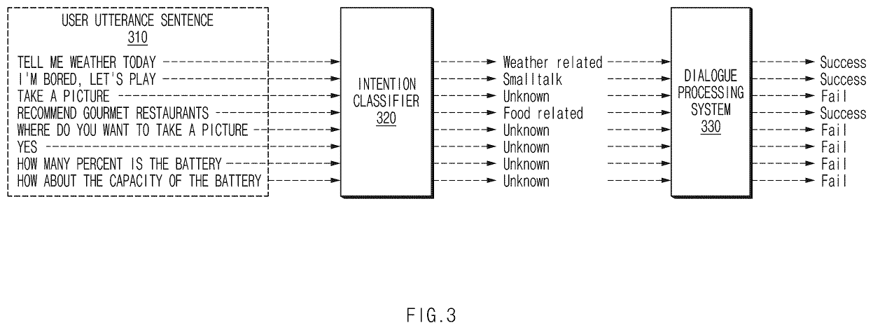

FIG. 3 is a diagram illustrating a method by an utterance intention determining apparatus for identifying a target sentence, according to an embodiment of the present disclosure.

Referring to FIG. 3, a user utterance sentence 310 may include at least one sentence. The user utterance sentence 310 may be applied to the intention classifier 320 by a processor (e.g., the processor 110 of FIG. 1) or a server (e.g., the server 140 of FIG. 1).

In an embodiment, the server 140 may obtain utterance intention of at least one respective sentence included in the user utterance sentence 310 by applying the user utterance sentence 310 to the intention classifier 320. However, the server 140 may fail to classify the utterance intention of a sentence with utterance intention that is not predetermined by the intention classifier 320.

The server 140 may apply the utterance intention obtained from the intention classifier 320 to a dialogue processing system 330. The server 140 may perform a scenario for a sentence classified by utterance intention among the user utterance sentence 310 based on the dialogue processing system 330. In an embodiment, the server 140 may control a robot such that the robot responds to a user's request by transmitting to the robot a scenario corresponding to a sentence for which the utterance intention is classified.

The server 140 may not apply the utterance intention which was not previously obtained from the intention classifier 320 to the dialogue processing system 330. In this case, for sentences whose utterance intent was not previously classified, the server 140 may not control the robot such that the robot may respond to the user's request.

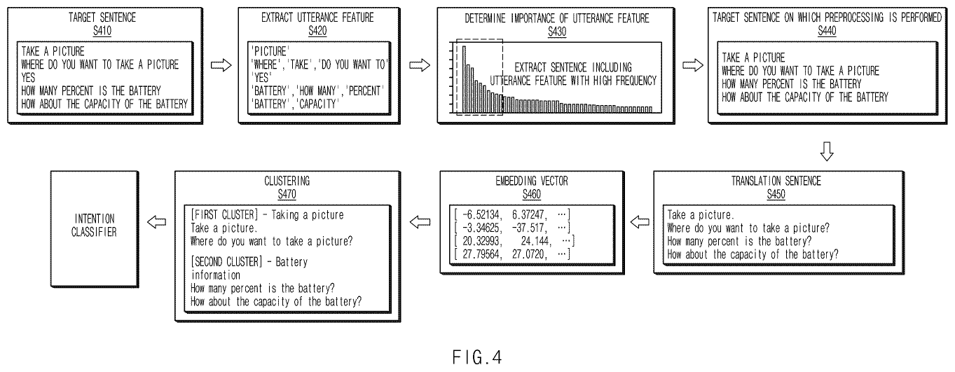

FIG. 4 is a diagram illustrating a method by an utterance determining apparatus for obtaining an utterance intention of a target sentence for which utterance intention was not previously determined, according to an embodiment of the present disclosure.

According to an embodiment, in operation S410, a processor (e.g., the processor 110 of FIG. 1) may identify at least one target sentence for which the utterance intention is not determined by a server (e.g., the server 140 of FIG. 1), from among user utterance sentences.

In operation S420, the processor may perform preprocessing based on at least one utterance feature included in at least one target sentence. In an embodiment, the processor may perform tokenization, stopword removal, and morphological analysis on at least one respective target sentence. Referring to FIG. 4, the processor may perform preprocessing on the sentence “Take a picture” as “picture” through tokenization, stopword removal, and morphological analysis.

In operation S430, the processor may determine the importance of the utterance feature. In an embodiment, the processor may extract a stem, which is repeated by a specific number of times, by measuring the number of times that each stem appears. In particular, the processor may determine that an utterance including a word is significant based on the word being repeated frequently. In an embodiment, if the length of the stem is at least two or more characters or if it is repeated multiple times in at least one target sentence, the processor may extract the corresponding stem.

In operation S440, the processor may identify the target sentence on which the preprocessing is performed. Referring to FIG. 4, the processor may exclude a sentence such as “yes”, which includes low importance of the utterance feature.

In operation S450, the processor may obtain a translation sentence, in which the target sentence is changed, i.e., converted to or translated to, from an original language into a predetermined language (e.g., English), by applying the target sentence to an LLM. The processor may obtain the translation sentence to increase the performance of the LLM and to obtain an accurate embedding vector.

In operation S460, the processor may obtain the embedding vector. In an embodiment, the processor may obtain the embedding vector by applying the translation sentence to a Bidirectional Encoder Representations from Transformers (BERT) model.

In operation S470, the processor may perform clustering based on the obtained embedding vector. In an embodiment, the processor may perform clustering between translation sentences based on the embedding vector. In particular, the processor may analyze the similarity between target sentences by using the embedding vector obtained by an LLM and may perform clustering to determine semantically similar sentences as one group.

In an embodiment, the clustering may refer to an unsupervised learning method, not a supervised learning method and may indicate automatically forming a group based on the similarity between sentences without predefined labels. In this way, sentences, in which utterance intention is not defined or which are outside intention categories, may be grouped together to create new utterance intention by grouping sentences with similar patterns.

In an embodiment, after vectorizing translation sentences, the processor measures the similarity between the translation sentences by using cosine similarity. In detail, the cosine similarity refers to a method of measuring similarity by calculating an angle between two vectors. Two sentences are similar to each other as the angle is close to 1. The two sentences are dissimilar to each other as the angle is close to 0.

The processor may determine translation sentences with high cosine similarity as a group with similar meanings. A clustering algorithm may include K-Means Clustering, Density-Based Spatial Clustering of Applications with Noise (DBSCAN), or Hierarchical Clustering.

The processor may transmit and/or apply utterance intention, which is generated by performing clustering, to an intention classifier. In detail, the processor may obtain utterance intention of each of a first cluster and a second cluster by applying the first cluster and the second cluster to the LLM. The processor may transmit and/or apply the utterance intention, which is obtained from the LLM, to the intention classifier.

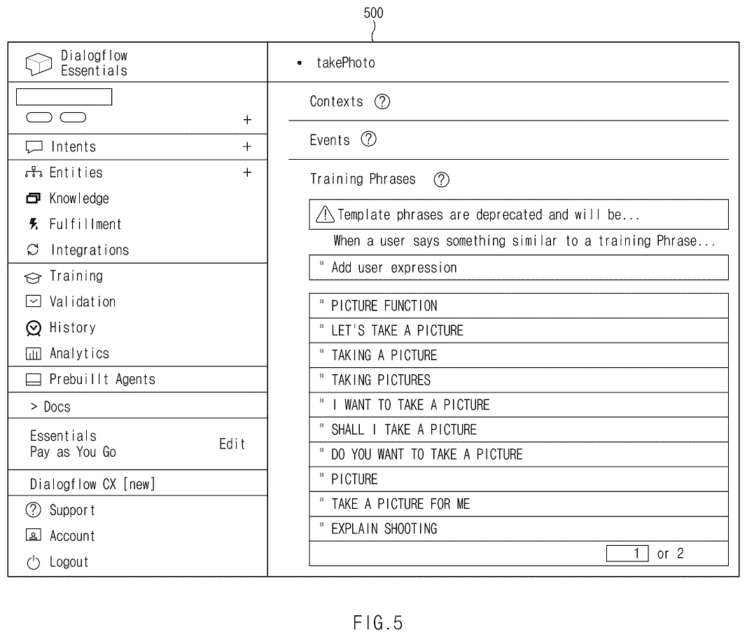

FIG. 5 is a diagram illustrating an interface for transmitting obtained utterance intention to an intention classifier in an utterance intention determining apparatus, according to an embodiment of the present disclosure.

Referring to FIG. 5, an utterance intention determining apparatus (e.g., the utterance intention determining apparatus 100 of FIG. 1) may provide an interface 500 to a user. In an embodiment, the interface 500 may represent an interface to Google's Dialogflow that is a conversational agent. In an embodiment, the utterance intention determining apparatus may add utterance intention “take a picture” to the intention classifier. The utterance intention determining apparatus may provide the utterance intention, which is added to the intention classifier, to the user through the interface 500.

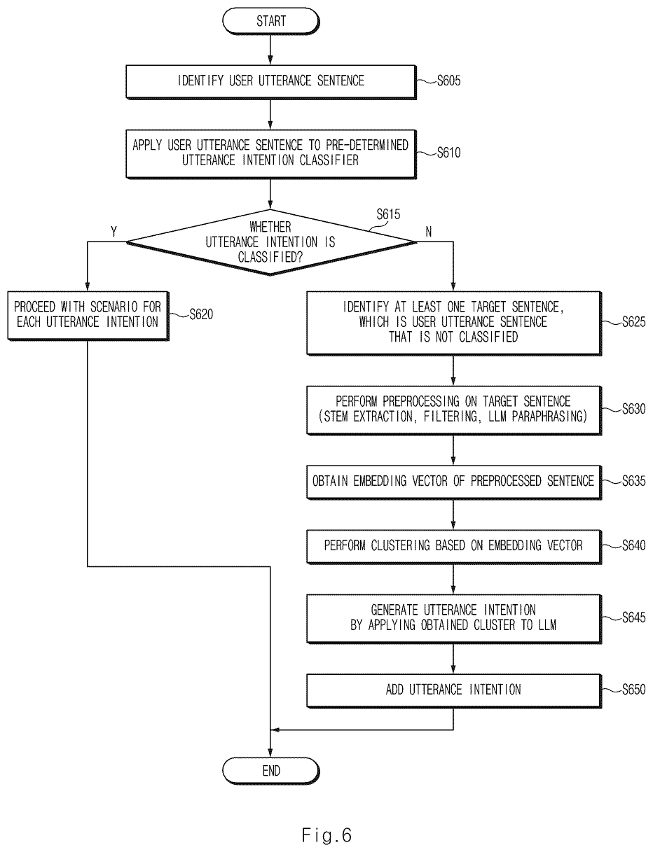

FIG. 6 is a flowchart illustrating a method, by an utterance intention determining apparatus, for obtaining utterance intention of a target sentence for which utterance intention is not determined, according to an embodiment of the present disclosure.

In operation S605, a processor (e.g., the processor 110 of FIG. 1) according to an embodiment may identify a user utterance sentence.

In operation S610, the processor may apply the user utterance sentence to a pre-determined utterance intention classifier.

In operation S615, the processor may determine whether utterance intention is classified. In operation S620 (YES in operation S615), the processor may proceed with a scenario for each utterance intention if the utterance intention is classified.

In operation S625 (NO in operation S615), the processor may identify at least one target sentence for which the utterance intention is not determined by an intention classifier of a server, from among user utterance sentences.

In operation S630, the processor may perform preprocessing on at least one target sentence based on at least one utterance feature included in at least one target sentence.

The processor may extract the at least one utterance feature from the at least one target sentence. The processor may perform preprocessing on the at least one target sentence based on at least one of the length of the at least one utterance feature, the number of times that the at least one utterance feature is repeated, or the importance of the at least one utterance feature, or any combination thereof.

In operation S635, the processor may obtain an embedding vector of the preprocessed sentence. The processor may extract a first target sentence and a second target sentence from the at least one target sentence.

The processor may obtain a first translation sentence, in which the first target sentence is changed, i.e., converted or translated, into from an original language to a predetermined language, by applying the first target sentence to the LLM. The processor may obtain a first embedding vector by applying the first translation sentence to a Bidirectional Encoder Representations from Transformers (BERT) model. The processor may obtain a second translation sentence, in which the second target sentence is changed, i.e., converted or translated, from an original language to a predetermined language, by applying the second target sentence to the LLM. The processor may obtain a second embedding vector by applying the second translation sentence to the BERT model.

In operation S640, the processor may perform clustering based on the embedding vector. In an embodiment, the processor may perform clustering on the first translation sentence and the second translation sentence based on the first embedding vector and the second embedding vector.

If the first translation sentence and the second translation sentence are included in the same cluster, in operation S645, the processor may obtain the utterance intention of the cluster by applying the first translation sentence and the second translation sentence to the LLM. The processor may obtain utterance intention of each of the first translation sentence and the second translation sentence by applying the first translation sentence and the second translation sentence to the LLM at different time points if the first translation sentence and the second translation sentence are included in different clusters.

In operation S650, the processor may add or transmit utterance intention to an intention classifier. In an embodiment, the processor may control a robot based on utterance intention of the at least one target sentence based on transmitting the utterance intention of the at least one target sentence to the server.

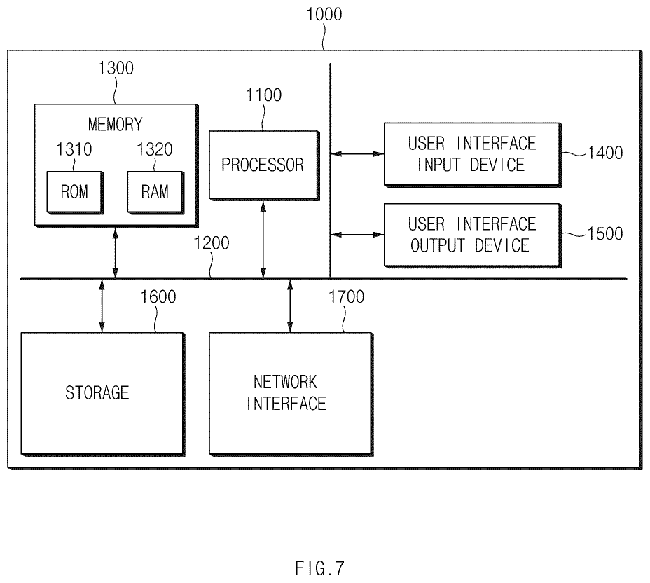

FIG. 7 is a diagram illustrating a computing system associated with an utterance intention determining apparatus or an utterance intention determining method, according to an embodiment of the present disclosure.

Referring to FIG. 7, a computing system 1000 associated with an utterance intention determining apparatus or an utterance intention determining method may include at least one processor 1100, a non-transitory memory 1300, a user interface input device 1400, a user interface output device 1500, a storage 1600, and a network interface 1700, which are connected, i.e., coupled with each other via a bus 1200.

The processor 1100 may be a specifically configured central processing unit (CPU) or a semiconductor device that processes computer-executable instructions stored in the memory 1300 and/or the storage 1600. Each of the memory 1300 and the storage 1600 may include various types of volatile or nonvolatile storage media. In an embodiment, the memory 1300 may include a read only memory (ROM) and a random access memory (RAM).

Accordingly, the operations of the methods or algorithms described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

Although various embodiments of the present disclosure have been described for illustrative purposes, those of ordinary skill in the art should appreciate that various modifications, additions, and substitutions are possible, without departing from the idea and scope of the claimed disclosure.

The above-described embodiments may be implemented with hardware elements, software elements, and/or a combination of hardware elements and software elements. In an embodiment, the devices, methods, and components described in embodiments of the present disclosure may be implemented by using general-use computers or special-purpose computers, such as a processor, a controller, an arithmetic logic unit (ALU), a digital signal processor, a microcomputer, a field programmable array (FPA), a programmable logic unit (PLU), a microprocessor, or any device which may execute instructions and respond. A processing device may perform an operating system (OS) or a software application running on the OS. Further, the processing device may access, store, manipulate, process and generate data in response to execution of software. It should be understood by those of ordinary skill in the art that although a single processing device may be illustrated for convenience of understanding, the processing device may include a plurality of processing elements and/or a plurality of types of processing elements. In an embodiment, the processing device may include a plurality of processors and/or controllers, or one processor and/or one controller. Also, the processing device may include different processing configurations, such as a parallel processor.

Software may include computer programs, codes, computer-executable instructions or one or more combinations thereof and configure a processing device to operate in a desired manner or independently or collectively control the processing device. Software and/or data may be permanently or temporarily embodied in any type of machine, components, physical equipment, virtual equipment, computer storage media or units to be interpreted by the processing device or to provide instructions or data to the processing device. Software may be dispersed throughout computer systems connected over networks and be stored or executed in a distributed manner. Software and data may be recorded in a computer-readable storage medium.

The methods according to the above-described embodiments may be recorded in a computer-readable medium including program instructions that are executable through various computer devices. The computer-readable medium may also include program instructions, data files, data structures, and the like, singly or in combination. The program instructions recorded in the medium may be designed and configured specially for the embodiments of the present disclosure or may be known and available to those of ordinary skill in the art. The computer-readable medium may include hardware devices, which are specifically configured to store and execute program instructions, such as magnetic media (e.g., a hard disk, a floppy disk, or a magnetic tape), optical recording media (e.g., CD-ROM and DVD), magneto-optical media (e.g., a floptical disk), read only memories (ROMs), random access memories (RAMs), and flash memories. Examples of the computer programs include not only machine language codes created by a compiler, but also high-level language codes that are capable of being executed by a computer by using an interpreter or the like.

The hardware device described above may be configured to act as one or more software modules to perform the operations of the above-described embodiments of the present disclosure, or vice versa.

Even though the embodiments are described with reference to restricted drawings, it may be obviously to one of ordinary skill in the art that the embodiments may be changed or modified based on the above description. In an embodiment, adequate effects may be achieved even though the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implementations, embodiments, and equivalents to the claims should be considered within the scope of the following claims.

Accordingly, various embodiments of the present disclosure are intended not to limit but to explain the technical idea of the present disclosure. The scope and spirit of the present disclosure is not limited by the above embodiments. The scope of protection of the present disclosure should be construed by the attached claims. All equivalents thereof should be construed as being included within the scope of the present disclosure.

Descriptions of an utterance intention determining apparatus according to various embodiments of the present disclosure, and a method thereof have been provided.

Moreover, according to at least one of various embodiments of the present disclosure, the utterance intention determining apparatus is configured to extract meaningful data from a user's utterance data, to construct utterance intention, and to respond to an utterance for which the intention is not previously classified.

In addition, a variety of effects directly or indirectly understood via the present disclosure may be provided.

Hereinabove, although the present disclosure was described with reference to various embodiments and the accompanying drawings, the present disclosure is not limited thereto, but may be variously modified and altered by those of ordinary skill in the art to which the present disclosure pertains without departing from the spirit and scope of the present disclosure claimed in the following claims.

What is claimed is:

1. An utterance intention determining apparatus comprising:
a memory configured to store computer-executable instructions; and
a processor coupled with the memory and configured to execute the computer-executable instructions stored in the memory to:
identify at least one target sentence for which utterance intention is not determined by a server, from speech information corresponding to speech of a user;
perform preprocessing on the at least one target sentence based on at least one utterance feature included in the at least one target sentence;
obtain the utterance intention of the at least one target sentence by applying the at least one target sentence to a large language model (LLM) based on performing preprocessing on the at least one target sentence; and
transmit the utterance intention of the at least one target sentence to the server.

2. The utterance intention determining apparatus of claim 1, wherein the processor is configured to:
extract the at least one utterance feature from the at least one target sentence; and
perform preprocessing on the at least one target sentence based on at least one of a length of the at least one utterance feature, a number of times that the at least one utterance feature is repeated, or importance of the at least one utterance feature, or any combination thereof.

3. The utterance intention determining apparatus of claim 1, wherein the processor is configured to:
extract a first target sentence and a second target sentence from the at least one target sentence;
obtain a first translation sentence based on the first target sentence being converted into a predetermined language by applying the first target sentence to the LLM; and
obtain a first embedding vector by applying the first translation sentence to a Bidirectional Encoder Representations from Transformers (BERT) model.

4. The utterance intention determining apparatus of claim 3, wherein the processor is configured to:
obtain a second translation sentence based on the second target sentence being converted into the predetermined language by applying the second target sentence to the LLM; and
obtain a second embedding vector by applying the second translation sentence to the BERT model.

5. The utterance intention determining apparatus of claim 4, wherein the processor is configured to:
perform clustering on the first translation sentence and the second translation sentence based on the first embedding vector and the second embedding vector.

6. The utterance intention determining apparatus of claim 5, wherein the processor is configured to:
obtain utterance intention of a cluster by applying the first translation sentence and the second translation sentence to the LLM based on the first translation sentence and the second translation sentence being included in the same cluster.

7. The utterance intention determining apparatus of claim 5, wherein the processor is configured to:
obtain utterance intention of each of the first translation sentence and the second translation sentence by applying the first translation sentence and the second translation sentence to the LLM at different time points based on the first translation sentence and the second translation sentence being included in different clusters.

8. The utterance intention determining apparatus of claim 1, wherein the processor is configured to:
control a robot based on the utterance intention of the at least one target sentence based on transmitting the utterance intention of the at least one target sentence to the server.

9. The utterance intention determining apparatus of claim 1, wherein the utterance feature includes at least one of a vocabulary of the target sentence, a topic of the target sentence, a dialect of the user, an intonation of the user, a stem of the target sentence, an ending of the target sentence, a pitch of the target sentence, or an utterance speed of the user, or any combination thereof.

10. An utterance intention determining method, the method comprising:
identifying at least one target sentence for which utterance intention was not previously determined by a server, from among speech information corresponding to speech of a user;
performing preprocessing on the at least one target sentence based on at least one utterance feature included in the at least one target sentence;
obtaining utterance intention of the at least one target sentence by applying the at least one target sentence to an LLM based on performing preprocessing on the at least one target sentence; and
transmitting the utterance intention of the at least one target sentence to the server.

11. The method of claim 10, wherein performing the preprocessing on the at least one target sentence includes:
extracting the at least one utterance feature from the at least one target sentence; and
performing preprocessing on the at least one target sentence based on at least one of a length of the at least one utterance feature, a number of times that the at least one utterance feature is repeated, or importance of the at least one utterance feature, or any combination thereof.

12. The method of claim 10, wherein obtaining the utterance intention of the at least one target sentence includes:
extracting a first target sentence and a second target sentence from the at least one target sentence;
obtaining a first translation sentence based on the first target sentence being converted into a predetermined language, by applying the first target sentence to the LLM; and
obtaining a first embedding vector by applying the first translation sentence to a BERT model.

13. The method of claim 12, wherein obtaining the utterance intention of the at least one target sentence includes:
obtaining a second translation sentence based on the second target sentence being converted into the predetermined language, by applying the second target sentence to the LLM; and
obtaining a second embedding vector by applying the second translation sentence to the BERT model.

14. The method of claim 13, wherein obtaining the utterance intention of the at least one target sentence includes:
performing clustering on the first translation sentence and the second translation sentence based on the first embedding vector and the second embedding vector.

15. The method of claim 14, wherein obtaining the utterance intention of the at least one target sentence includes:
obtaining utterance intention of a cluster by applying the first translation sentence and the second translation sentence to the LLM based on the first translation sentence and the second translation sentence being included in the same cluster.

16. The method of claim 14, wherein obtaining the utterance intention of the at least one target sentence includes:
obtaining utterance intention of each of the first translation sentence and the second translation sentence by applying the first translation sentence and the second translation sentence to the LLM at different time points based on the first translation sentence and the second translation sentence being included in different clusters.

17. The method of claim 10, wherein transmitting the utterance intention of the at least one target sentence to the server includes:
controlling a robot based on the utterance intention of the at least one target sentence based on transmitting the utterance intention of the at least one target sentence to the server.

18. The method of claim 10, wherein the utterance feature includes at least one of a vocabulary of the target sentence, a topic of the target sentence, a dialect of the user, an intonation of the user, a stem of the target sentence, an ending of the target sentence, a pitch of the target sentence, or an utterance speed of the user, or any combination thereof.
